(19) United States
(12) Patent Application Publication
(10) Pub. No.: US 2021/0062583 A1
(43) Pub. Date: Mar. 4, 2021

(54) Ladder Pad Apparatus

(71) Applicants: John Greynolds, Fairmont, WV (US); Rebecca Greynolds, Fairmont, WV (US)

(72) Inventors: John Greynolds, Fairmont, WV (US); Rebecca Greynolds, Fairmont, WV (US)

(21) Appl. No.: 16/560,449

(22) Filed: Sep. 4, 2019

(51) Int. Cl. E06C 7/48

(52) U.S. Cl. CPC E06C 7/48

(57) ABSTRACT

A ladder pad apparatus for protecting surfaces from being damaged by a ladder includes a pad body having a top side, a bottom side, a left side, a right side, a front side, and a back side. The back side has a medial slot extending towards the front side from the top side to the bottom side. The slot is configured to receive a ladder. The pad body is a resilient cushioning material. At least one strap is coupled to the pad body. Each strap has a proximal end coupled to the left side and a first and second mating member coupled to a distal end of the strap and the right side of the pad body, respectively. The first and second mating members are selectively engageable to secure the strap and the strap is configured to secure the apparatus to the ladder.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ladder accessory devices and more particularly pertains to a new ladder accessory device for protecting surfaces from being damaged by a ladder.

### (2) Description of Related Art Including Information Disclosed Under 37 CFR 1.97 and 1.98

The prior art relates to ladder accessory devices.

### BRIEF SUMMARY OF THE INVENTION

An embodiment of the disclosure meets the needs presented above by generally comprising a pad body having a top side, a bottom side, a left side, a right side, a front side, and a back side. The back side has a medial slot extending towards the front side from the top side to the bottom side. The slot is configured to receive a ladder. The pad body is a resilient cushioning material. At least one strap is coupled to the pad body. Each strap has a proximal end coupled to the left side proximal the back side and a first and second mating member coupled to a distal end of the strap and the right side of the pad body proximal the back side, respectively. The first and second mating members are selectively engageable to secure the strap and the strap is configured to secure the apparatus to the ladder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a ladder pad apparatus according to an embodiment of the disclosure.

FIG. 2 is an isometric view of an embodiment of the disclosure.

FIG. 3 is an in-use view of an embodiment of the disclosure.

FIG. 4 is a cross-sectional view along the line 4-4 of FIG. 3 of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

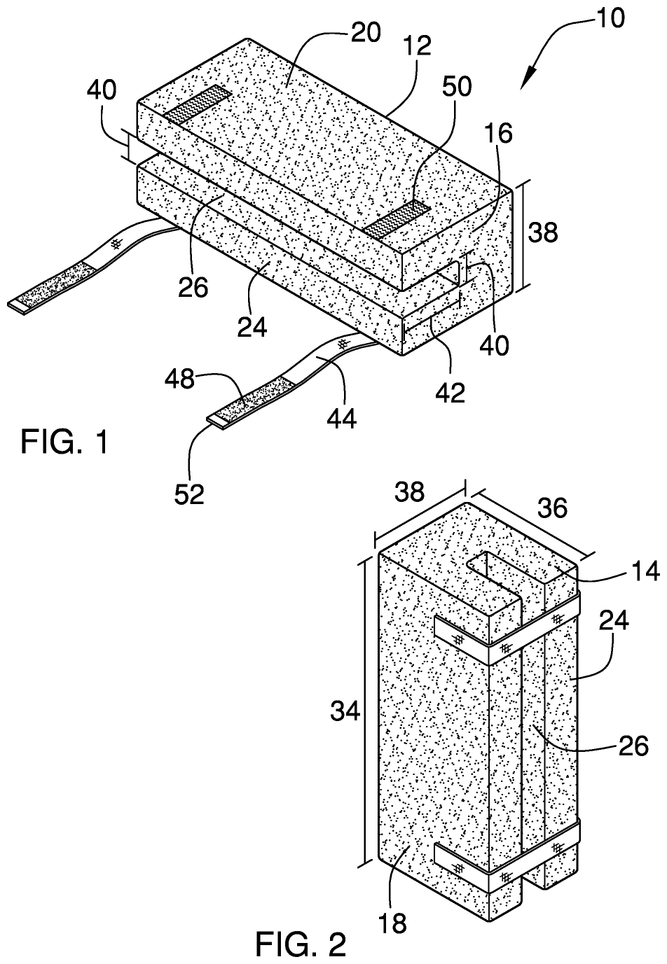

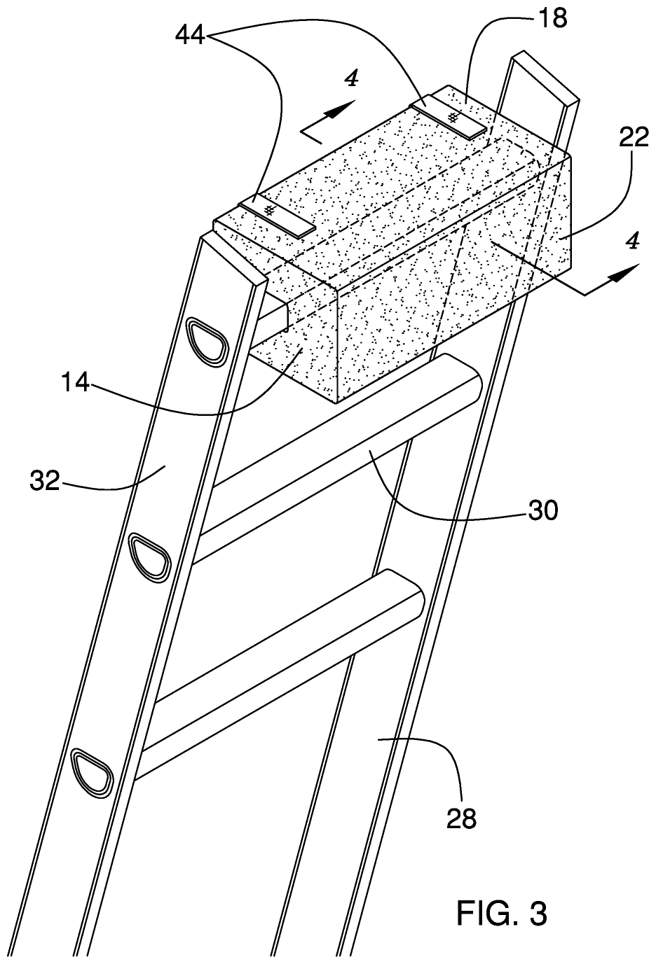

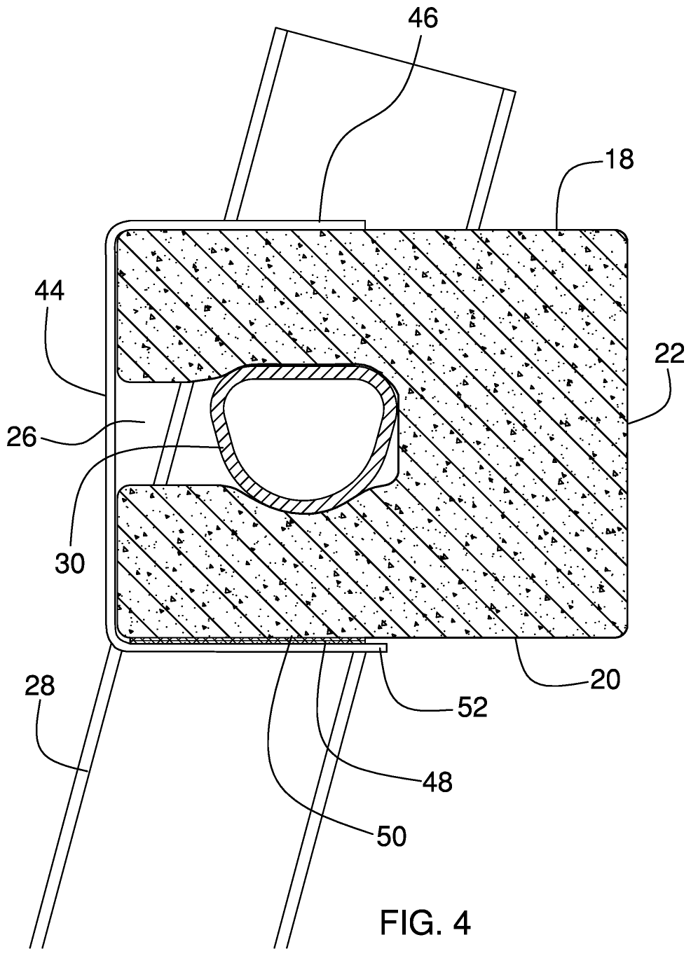

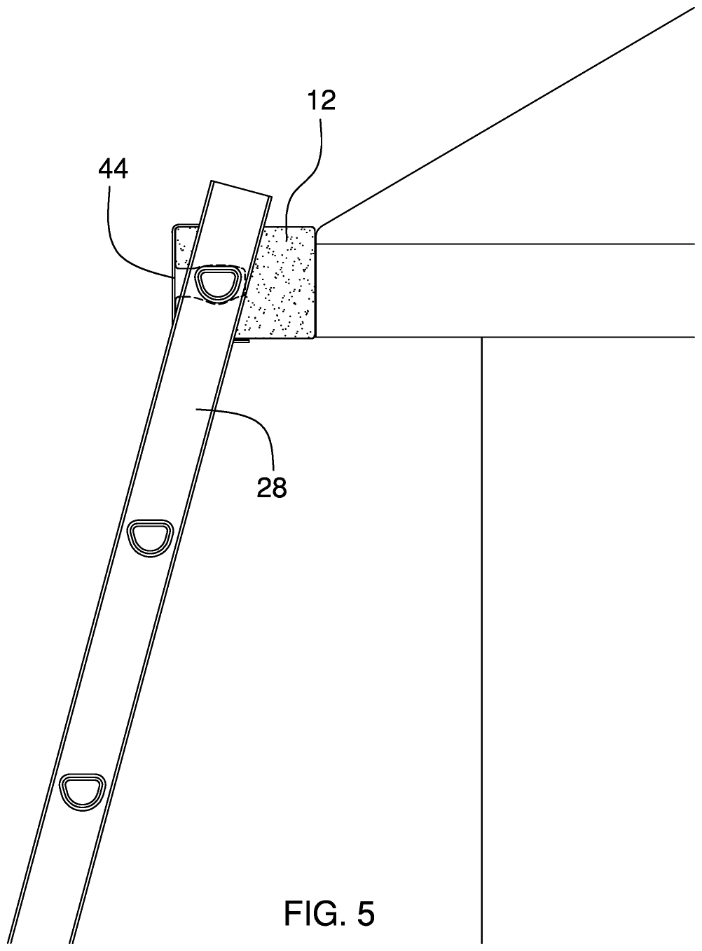

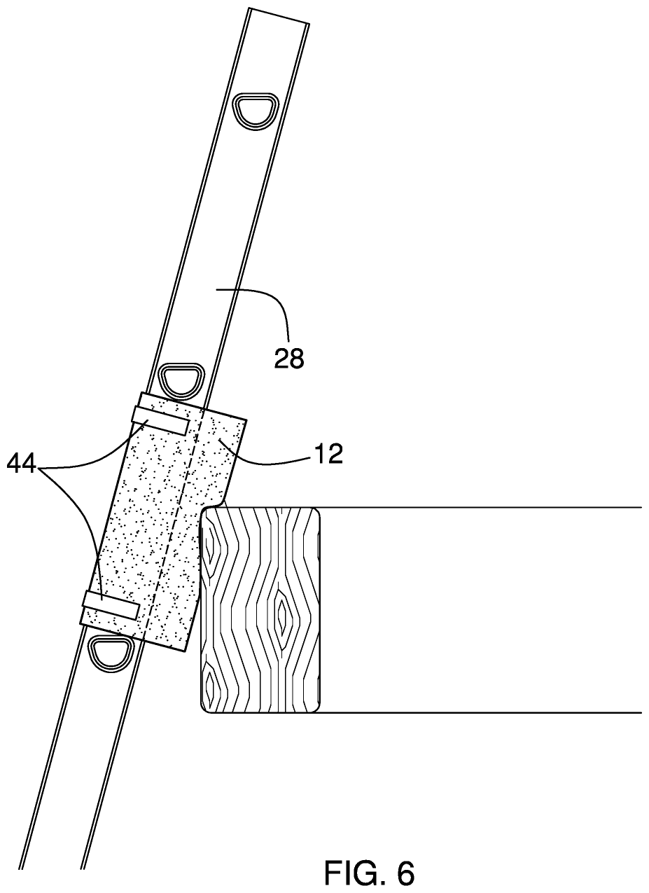

With reference now to the drawings, and in particular to FIGS. 1 through 6 thereof, a new ladder accessory device embodying the principles and concepts of an embodiment of the disclosure and generally designated by the reference numeral 10 will be described.

As best illustrated in FIGS. 1 through 6, the ladder pad apparatus 10 generally comprises a pad body 12 having a top side 14, a bottom side 16, a left side 18, a right side 20, a front side 22, and a back side 24. The back side 24 has a medial slot 26 extending towards the front side 22 from the top side 14 to the bottom side 16. The slot 26 is configured to receive a ladder 28. The slot 26 may receive a rung 30 or a side rail 32 of the ladder 28 to prevent the ladder 28 from directly contacting and damaging a surface such as, but not limited to, a wall, a rafter, a gutter, or other structure. The pad body 12 may be rectangular prismatic and has a pad height 34 between the top side 14 and the bottom side 16 greater than a pad depth 36 between the front side 22 and the back side 24. The pad depth 36 is greater than a pad width 38 between the left side 18 and the right side 20. The pad height 34 may be 2.4 times the pad depth 36 and the pad depth 36 may be 25% greater than the pad width 38. A slot width 40 of the slot is equal to 25% of the pad width 38 and a slot depth 42 of the slot is equal to 60% of the pad depth 36. The pad height 34, the pad depth 36, and the pad width 38 may be 12 inches, five inches, and four inches, respectively. The slot width 40 and the slot depth 42 may be one inch and three inches, respectively. The pad body 12 is a resilient cushioning material such as, but not limited to, medium density foam, high density foam, memory foam, and the like.

At least one strap 44 is coupled to the pad body 12. Each strap 44 has a proximal end 46 coupled to the left side 18 proximal the back side 24 and a first 48 and second mating member 50 coupled to a distal end 52 of the strap and the right side 20 of the pad body proximal the back side 24, respectively. The first 48 and second mating members 50 are selectively engageable to secure the strap 44 and the strap 44 is configured to secure the apparatus 10 to the ladder 28. The at least one strap 44 may be a pair of straps 44 disposed proximal the top side 14 and the bottom side 16. The first 48 and second mating members 50 may comprise a hook and loop fastener or other type of releasable fastener such as, but not limited to, buttons, snaps, and the like. The second mating member 50 may be oriented perpendicular to the back side 24 to allow a length of the strap 44 to be adjusted accordingly to the appropriate size of the element of the ladder 28 to which the apparatus 10 is being secured.

In use, the rung 30 or side rail 32 of the ladder is placed within the slot 26 and the straps 44 are wrapped around the ladder 28. The first 48 and second mating members 50 are engaged to secure the apparatus 10 in place. The ladder 28 may then be used with the apparatus 10 serving as a buffer to prevent damage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ladder pad apparatus comprising:
a pad body, the pad body having a top side, a bottom side, a left side, a right side, a front side, and a back side, the back side having a medial slot extending towards the front side from the top side to the bottom side, the slot being configured to receive a ladder, the pad body being a resilient cushioning material; and
at least one strap coupled to the pad body, each strap having a proximal end coupled to the left side proximal the back side and a first and second mating member coupled to a distal end of the strap and the right side of the pad body proximal the back side, respectively, the first and second mating members being selectively engageable to secure the strap, the strap being configured to secure the apparatus to the ladder.

2. The ladder pad apparatus of claim 1 further comprising the at least one strap being a pair of straps disposed proximal the top side and the bottom side.

3. The ladder pad apparatus of claim 1 further comprising the pad body being rectangular prismatic.

4. The ladder pad apparatus of claim 3 further comprising the pad body having a pad height between the top side and the bottom side greater than a pad depth between the front side and the back side, a pad width between the left side and the right side being less than the pad depth.

5. The ladder pad apparatus of claim 4 further comprising a slot depth of the slot being greater than 50% of the pad depth.

6. The ladder pad apparatus of claim 3 further comprising the pad body having a pad height between the top side and the bottom side greater than twice a pad depth between the front side and the back side, the pad depth being at least 25% greater than a pad width between the left side and the right side.

7. The ladder pad apparatus of claim 3 further comprising the pad body having a pad height between the top side and the bottom side equal to 2.4 times a pad depth between the front side and the back side, the pad depth being 25% greater than a pad width between the left side and the right side.

8. The ladder pad apparatus of claim 7 further comprising a slot width of the slot being equal to 25% of the pad width and a slot depth of the slot being equal to 60% of the pad depth.

9. The ladder pad apparatus of claim 1 further comprising the first and second mating members comprising a hook and loop fastener or other type of releasable fastener such as, but not limited to, buttons, snaps, and the like.

10. A ladder pad apparatus comprising:
a pad body, the pad body having a top side, a bottom side, a left side, a right side, a front side, and a back side, the back side having a medial slot extending towards the front side from the top side to the bottom side, the slot being configured to receive a ladder, the pad body being rectangular prismatic and having a pad height between the top side and the bottom side greater than twice a pad depth between the front side and the back side, the pad depth being at least 25% greater than a pad width between the left side and the right side, a slot width of the slot being equal to 25% of the pad width and a slot depth of the slot being equal to 60% of the pad depth, the pad body being a resilient cushioning material; and
at least one strap coupled to the pad body, each strap having a proximal end coupled to the left side proximal the back side and a first and second mating member coupled to a distal end of the strap and the right side of the pad body proximal the back side, respectively, the first and second mating members being selectively engageable to secure the strap, the strap being configured to secure the apparatus to the ladder, the at least one strap being a pair of straps disposed proximal the top side and the bottom side, the first and second mating members comprising a hook and loop fastener or other type of releasable fastener such as, but not limited to, buttons, snaps, and the like.
